(19) United States
(12) Patent Application Publication
(10) Pub. No.: US 2005/0025857 A1
(43) Pub. Date: Feb. 3, 2005

(54) High protein, low carbohydrate food composition having non-fermentable fiber

(76) Inventors: William David Schoenherr, Hoyt, KS (US); Claudia Kirk, Louisville, TN (US); Kim Gene Friesen, Topeka, KS (US); Harry Mead Clark, Topeka, KS (US); Craig Richard Cowley, Meriden, KS (US)

Correspondence Address: HARNESS, DICKEY, & PIERCE, P.L.C, 7700 BONHOMME, STE 400, ST. LOUIS, MO, 63105, US

(21) Appl. No.: 10/860,424

(22) Filed: Jun. 3, 2004

Related U.S. Application Data
(60) Provisional application No. 60/475,424, filed on Jun. 3, 2003.

(51) Int. Cl. A01K 1/00

(52) U.S. Cl. 426/2

(57) ABSTRACT

A food composition is provided having high protein levels, high fat levels, low carbohydrate levels and non-fermentable fiber. Methods of using these compositions for weight management in mammals are also provided.

### CROSS REFERENCE TO RELATED APPLICATION

This application claims the benefit of U.S. Provisional Application No. 60/475,424, filed on Jun. 3, 2003, which is hereby incorporated in its entirety by reference.

### FIELD OF THE INVENTION

The invention provides food compositions containing high protein, high fat, and low carbohydrate levels which also contain non-fermentable fiber, and methods of using same.

### BACKGROUND OF THE INVENTION

Weight management is an issue for companion animals. Approximately 25% of cats and dogs are overweight and/or obese. The term overweight includes those animals that are above normal body weight up through and including obesity. A number of approaches have been used in an attempt to control feline or canine body weight, particularly in those cats or dogs which have a tendency to become overweight or those cats or dogs which are already overweight. Food with overall reduced calories, reduced fat content, or reduced carbohydrates have all been employed.

Many commercial pet foods are enhanced with fiber in order to produce satiety and reduce food intake. A less traditional approach to weight management utilizes high protein and low carbohydrate.

Thus, it would be a significant contribution to the art to provide a nutritionally balanced food composition that is high in protein, high in fat, and low in carbohydrate, and which also contains non-fermentable fiber that is useful in managing weight in mammals that are overweight or that may have a tendency to become overweight, especially where said mammal is a dog or a cat.

### SUMMARY OF THE INVENTION

The present invention provides a food composition for a mammal having high protein, high fat, low carbohydrate, and non-fermentable fiber.

The present invention further provides a method for feeding a mammal the above composition wherein said mammal is in need of weight management.

### DETAILED DESCRIPTION OF THE INVENTION

Weight management in companion animals, as well as humans, has been an increasingly significant problem in recent years. It is now estimated that approximately 25% of pet dogs and cats in the U.S. are overweight and/or obese. Various methods and products for managing weight in mammals have been previously employed.

High protein, low carbohydrate foods are known in the art, and are frequently referred to as “ketogenic” foods. A specific example of the use of a ketogenic food would be the popular “Atkins Diet”, which uses foods high in protein, high in fat, and low in carbohydrate content.

The present invention provides a food composition having high protein levels, high fat levels, low carbohydrate levels, and non-fermentable fiber that is useful in managing weight in mammals, especially companion animals, and particularly for use in dogs or cats. The addition of non-fermentable fiber to a feline or canine food having high protein, high fat, and low carbohydrate can increase the rate of weight change, and/or can provide less lean tissue loss, and/or can increase the rate of fat loss compared to the low carbohydrate food without added non-fermentable fiber.

The term “wt %” as employed throughout the specification and claims refers to wt % calculated on a dry matter basis.

The above compositions and methods are particularly useful wherein the overweight condition of the companion animal is not due to a disease state resulting from carbohydrate metabolism, such as wherein the animal has diabetes.

The addition of non-fermentable fibers to a high protein, high fat, low carbohydrate food has been found to be advantageous for managing weight in dogs or cats. The non-fermentable fiber of the present composition can provide enhanced weight loss, for example, as expressed above, in addition to enhanced satiety.

The protein may be from any source. A protein source having low carbohydrates is particularly preferred. Examples of such protein sources include animal sources such as meat protein isolate, whey protein isolate, mixtures thereof, and the like, as well as vegetable sources, such as soy protein isolate, corn gluten meal, wheat gluten, mixtures thereof, and the like.

The fat may be from any source. Examples of such fat sources include poultry fat, beef tallow, lard, choice white grease, soybean oil, corn oil, canola oil, sunflower oil, mixtures thereof, and the like. The fat may be incorporated completely within the food composition, deposited on the outside of the food composition, or a mixture of the two methods.

The carbohydrate may be from any source, and may enter the food composition as part of another ingredient, such as the protein source. Examples of such carbohydrate sources include starches and grains, such as corn, wheat, sorghum, barley, rice, mixtures thereof, and the like.

The term non-fermentable fiber is defined as a fiber having an organic matter disappearance rate of less than 15%, preferably less than about 8 to 12%, when fermented by non-ruminant fecal bacteria in vitro for a 24 hour period. An alternative definition of non-fermentable fiber is any fiber source which may be fermented by intestinal bacteria present in the animal to produce less than 0.5 mmol of short chain fatty acids per gram of substrate in a 24 hour period. Examples of non-fermentable fibers include cellulose, hemicellulose, lignin, mixtures thereof, and the like. Examples of fermentable fibers include pectins, gums, and mucilages. The fiber, both fermentable and non-fermentable, are measured by AOAC Official Method 991.43.

Protein concentrations provided in the present food composition are from about 25 to about 70 wt %. Suitable representative minimum protein concentrations include 25, 40, 45, and 47 wt %. Suitable representative maximum protein concentrations include 60 and 70 wt %. Preferred for the present invention are protein concentrations of from about 40 to about 70 wt %. Additionally preferred for the practice of the present invention are protein concentrations of from about 45 to about 60 wt %. Particularly preferred for the practice of the present invention are protein concentrations of from about 47 to about 60 wt %. Fat concentrations provided in the present food composition are from about 10 to about 70 wt %. Suitable representative minimum fat concentrations include 10 and 20 wt %. Suitable representative maximum fat concentrations include 60 and 70 wt %. Preferred for the present invention are fat concentrations of from about 20 to about 70 wt %. Particularly preferred for the practice of the present invention are fat concentrations of from about 20 to about 60 wt %. Carbohydrate concentrations provided in the present food composition are based on Nitrogen Free Extract (NFE) determinations and are from about 0 to about 25 wt %. Suitable representative minimum carbohydrate concentrations include 0, 5, and 10 wt %. Suitable representative maximum carbohydrate concentrations include 12, 15, and 20 wt %. Preferred for the present invention are carbohydrate concentrations of from about 10 to about 20 wt %. Additionally preferred for the present invention are carbohydrate concentrations of from about 12 to about 20 wt %. Particularly preferred for the practice of the present invention are carbohydrate concentrations of from about 12 to about 15 wt %. Non-fermentable fiber concentrations provided in the present food composition are from about 0.75 to about 20 wt %. Suitable representative minimum non-fermentable fiber concentrations include 0.75, 3, 5, 7, and 8 wt %. Suitable representative maximum non-fermentable fiber concentrations include 10, 12, 15, and 20 wt %. Preferred for the present invention are non-fermentable fiber concentrations of from about 5 to about 15 wt %. Particularly preferred for the practice of the present invention are non-fermentable fiber concentrations of from about 7 to about 10 wt %.

Particularly preferred for the practice of the present invention is a food composition containing protein concentrations of about 51 to 53 wt %, fat concentrations of about 21 to 23 wt %, carbohydrate concentrations of about 15 to 16 wt %, and non-fermentable fiber concentrations of about 8 to 10 wt %.

When the term “food” is used, this may refer not only to a food product which typically provides most, if not all, the nutrient value for a companion animal, but may also refer to such items as a snack, treat, supplement, and the like.

The food composition may be provided to any mammal, particularly a companion animal, such as a dog or cat, which is in need of weight management. The animal, especially a dog or cat, may be one which is currently overweight or one which has a tendency to become overweight, and preferably where the weight issue does not arise from a disease of abnormal carbohydrate metabolism, such as, for example, diabetes. The need for weight management in the dog or cat may arise due to the animal expending fewer calories than those being ingested. For example, this may result from overeating, insufficient activity, a combination of the two, or for other unknown reasons. Temporary abnormal carbohydrate metabolism is not a disease and may result from trauma to the animal, such as illness, injury, or surgery, and the like. Temporary abnormal carbohydrate metabolism may also result from feeding an animal an improper diet, such as, for example, feeding a diet that is high in carbohydrates. For example, cats and dogs differ in their ability to process carbohydrates and fats based on different enzyme functionality, such as liver and pancreatic enzymes. High intake of carbohydrates by an animal adapted to an almost exclusive intake of fat and protein may result in an abnormal regulation of hormones and enzymes that signal the fed and unfed state to the body. This may result in temporary abnormal carbohydrate metabolism, wherein the normal carbohydrate metabolic state returns to the animal once the carbohydrate levels in the food have been altered.

Obesity, by definition, is the accumulation of an excessive quantity of fat. Body weight increases as fat accumulates; thus, having excessive body fat and being overweight are related. Obesity develops when animals are in a positive energy balance for an extended period of time. This occurs when energy intake increases, energy expenditure decreases, or both occur.

Body weight relative to an animal's optimal weight has been used as a defining criterion for obesity because body weight is easier to measure than body fat. Overweight dogs and cats are subdivided into three categories:
1) those animals 1 to 9% above optimal weight that are simply above optimal weight,
2) those animals 10 to 19% above optimal weight that are considered overweight; and
3) those animals 20% above optimal weight that are considered obese.

Categories 2) and 3) above are those categories addressed by the present invention for reducing weight in overweight and/or obese animals.

Physical activity significantly influences the energy requirements of individual dogs and cats. Animals that are prone to become obese typically have lower levels of physical activity than those that are not prone to become obese.

The effect provided by the present composition including the non-fermentable fibers has been observed in the dog or cat as an increase in the rate of weight change and/or a decrease in lean tissue loss and/or an increased rate of fat loss. These observations may be made in animals which are already overweight, where the feeding of the food composition is intended to alleviate or reduce this issue. With respect to mammals having a tendency to be overweight or obese, these or similar observations related to the kinetics and/or specificity of weight control may be made.

### EXAMPLES

The effect on cats and dogs of a food having increased amounts of non-fermentable fiber was assessed in the following experiments.

### Example 1

### Cat Study

Experimental Design: On day 0 obese cats were weighted, anesthetized, and body composition was determined via Dual Energy X-Ray Absorptiometry (DEXA). Animals were allotted to treatments based on body composition, weight, and gender. Beginning on day 1, each cat received a randomly assigned food and the animals remained on their respective weight loss dietary treatment for the duration of the study. The canned foods used in this study were in one of two forms, a conventional loaf or minced food preparation.

For the weight loss period, each cat received its daily food amount based on energy requirements of its ideal body weight (20% body fat). The formula used to determine the amount of calories offered to each animal was as follows: kcal offered per day=0.8×(70×ideal body weight (kg)^{0.75}). The amount of food offered daily to each animal was calculated by dividing the amount of calories to be offered by the caloric density of the food (kcal/kg). Use of this equation allowed animals to lose body weight at a rate of 1.0 to 1.5% of their initial body weight per week. Initial body composition was determined by DEXA. Ideal body weight was estimated by calculating fat-free body mass from the DEXA analysis and adding 20% fat to this total.

The end of the study was determined for each animal by its meeting a body fat percentage of 20% or at the completion of 24 weeks on study. All cats were weighed weekly and DEXA'd every 4 weeks to measure their individual progress in weight loss.

TABLE 1

| | Feline | Feline | Feline |
|---|---|---|---|
| | Low CHO Added | Low CHO Added | Low CHO Added |
| | Non-fermentable | Non-fermentable | No Non-fermentable |
| | Fiber | Fiber | Fiber |
| Description | Canned - Loaf | Canned - Minced | Canned - Minced |
| Nutrient Analysis | | | |
| (100% DM Basis) | | | |
| Protein, % | 61.34 | 56.06 | 59.93 |
| Fat, % | 14.14 | 20.56 | 27.38 |
| Total Dietary Fiber, % | 11.25 | 11.02 | 1.96 |
| Fermentable Fiber, % | .18 | 1.97 | 1.86 |
| Non-fermentable Fiber, % | 11.07 | 9.05 | 0.10 |
| Ash, % | 4.98 | 5.68 | 5.78 |
| NFE, % Calculated | 10.51 | 10.07 | 6.44 |
| ME, Kcal/kg Calculated | 3717 | 4075 | 4531 |
| Ingredient | | | |
| Water, % | 16.13 | 25.07 | 33.63 |
| Meat By-Products, % | 60.00 | 68.13 | 58.50 |
| Starch, % | 2.00 | 1.61 | 1.05 |
| Meat or Soy Isolate, % | 7.99 | 1.00 | 2.50 |
| Cellulose | 4.00 | 2.23 | — |
| Corn Gluten Meal, % | 4.50 | — | — |
| Animal Fat, % | 1.84 | 0.45 | 2.68 |
| Pal Enhancer, % | 1.20 | — | — |
| Gravy System, % | — | 0.53 | 0.63 |
| Minerals, % | 2.15 | 0.79 | 0.81 |
| Vitamins, % | 0.19 | 0.19 | 0.20 |
| Total, % | 100.00 | 100.00 | 100.00 |

TABLE 2
EFFECT OF FIBER ON WEIGHT LOSS IN OBESE CATS FED HIGH PROTEIN,
LOW CARBOHYDRATE FOODS

| | | Rate of Weight | Rate of Fat | Rate of Lean |
|---|---|---|---|---|
| | Non-fermentable | Change, | Tissue Change, | Tissue Change, |
| Formula Description | Dietary Fiber, % | g/d | g/d | g/d |
| Low CHO w/o | .10 | −10.0 | −8.5 | −1.4 |
| Fiber, Minced | | | | |
| Low CHO w/Fiber | 11.07 | −11.2 | −10.1 | −0.5 |
| Loaf | | | | |
| Low CHO w/Fiber, | 9.05 | −10.3 | −9.5 | −0.7 |
| Minced | | | | |

The food was provided for a span of about 112 to about 168 days.

Results: The combined weight loss data showed that cats fed high protein, low carbohydrate foods had effective weight loss. The rate of weight change was further increased when fiber was added to the foods. Thus, a low carbohydrate food without added non-fermentable fiber gave effective weight loss, however, the addition of the non-fermentable fiber further increased the rate of weight change. The addition of fiber to a low carbohydrate food also resulted in less lean tissue loss and an increase in the rate of fat loss compared to low carbohydrate foods without fiber.

### Example 2

### Dog Study

Experimental Design: On day 0 obese dogs were weighed, anesthetized, and body composition was determined via Dual Energy X-Ray Absorptionmetry (DEXA). Animals were allotted to treatments based on body composition, weight and gender. Beginning on day 1, each dog received a randomly assigned food and the animals remained on their respective weight loss dietary treatment for the duration of the study.

For the weight loss period, each dog received its daily food amount based on energy requirements of its ideal body weight (20% body fat). The formula used to determine the amount of calories offered to each animal was as follows: kcal offered per day=1.0×(70×ideal body weight (kg)^{0.75} ). The amount of food offered daily to each animal was calculated by dividing the amount of calories to be offered by the caloric density of the food (kcal/kg). Use of this equation allowed animals to lose body weight at a rate of 1.5 to 2.0% of their initial body weight per week. Initial body composition was determined by DEXA. Ideal body weight was estimated by calculating fat-free body mass from the DEXA analysis and adding 20% fat to this total.

The end of the study was determined for each animal by its meeting a body fat percentage of 20% or at the completion of 16 weeks on study. All dogs were weighed weekly and DEXA'd every 4 weeks to measure their individual progress in weight loss.

The following Table shows the nutrient analysis and ingredient content of two canned foods with and without added non-fermentable fiber. Ingredients with low moisture content are added to canned foods at low concentrations to account for the high moisture in the final product.

TABLE 3

| | Canine | Canine |
|---|---|---|
| | Low CHO Added | Low CHO Added |
| | Non-Fermentable | No Non-fermentable |
| | Fiber; | Fiber; |
| | Canned - | Canned |
| Description | Minced | Minced |
| Nutrient Analysis | | |
| (100% DM Basis) | | |
| Protein, % | 48.78 | 50.00 |
| Fat, % | 28.72 | 30.24 |
| Total Dietary Fiber, % | 10.05 | 3.94 |
| Fermentable Fiber, % | 1.60 | 1.72 |
| Non-fermentable Fiber, % | 8.45 | 2.22 |
| Ash, % | 4.89 | 5.96 |
| NFE, % Calculated | 12.01 | 12.99 |
| ME, Kcal/kg | 4359 | 4781 |

TABLE 4

| | Canine | Canine |
|---|---|---|
| | Low CHO | Low CHO |
| | Non-Fermentable | No Non-Fermentable |
| | Fiber | Fiber |
| Description | Canned - Minced | Canned - Minced |
| Ingredient | | |
| Water, % | 34.11 | 28.60 |
| Meat By-Products, % | 56.40 | 61.42 |
| Starch, % | 1.50 | 1.50 |
| Meat or Soy Isolate, % | 1.40 | 1.65 |
| Cellulose | 2.11 | 0.67 |
| Animal Fat, % | 2.87 | 4.53 |
| Gravy System, % | 0.61 | 0.55 |
| Minerals, % | 0.72 | 0.84 |
| Vitamins, % | 0.28 | 0.24 |
| Total, % | 100.00 | 100.00 |

TABLE 5
EFFECT OF NON-FERMENTABLE FIBER ON WEIGHT LOSS IN
OBESE DOGS FED HIGH PROTEIN, LOW CARBOHYDRATE FOODS

| | Non- | Rate of | Rate of Fat | Rate of Lean |
|---|---|---|---|---|
| | Fermentable | Weight | Tissue | Tissue |
| Formula Description | Dietary Fiber, % | Change, g/d | Change, g/d | Change, g/d |
| Low CHO w/Fiber minced | 8.45 | −48.1 | −37.6 | −10.1 |
| Low CHO w/o Fiber minced | 2.22 | −46.0 | −36.5 | −9.1 |

The food was provided for a span of about 52 to about 112 days.

Results: The weight loss data showed that dogs fed the high protein, low carbohydrate foods had effective weight loss. The rate of weight change and fat tissue change was further increased when fiber was added to the food. Thus, a low carbohydrate food without fiber gave effective weight loss, however, the addition of fiber further increased the rate of weight change and fat change to the benefit of the animal.

### Example 3

### Dog Study With Dry Food

Experimental Design: On day 0 obese dogs were weighed, anesthetized, and body composition was determined via Dual Energy X-Ray Absorptionmetry (DEXA). Animals were allotted to treatments based on body composition, weight and gender. Beginning on day 1, each dog received a randomly assigned food and the animals remained on their respective weight loss dietary treatment for the duration of the study.

For the weight loss period, each dog received its daily food amount based on energy requirements of its ideal body weight (20% body fat). The formula used to determine the amount of calories offered to each animal was as follows: kcal offered per day=1.0×(70×ideal body weight (kg)). The amount of food offered daily to each animal was calculated by dividing the amount of calories to be offered by the caloric density of the food (kcal/kg). Use of this equation allowed animals to lose body weight at a rate of 1.5 to 2.0% of their initial body weight per week. Initial body composition was determined by DEXA. Ideal body weight was estimated by calculating fat-free body mass from the DEXA analysis and adding 20% fat to this total.

The end of the study was determined for each animal by its meeting a body fat percentage of 20% or at the completion of 16 weeks on study. All dogs were weighed weekly and DEXA'd every 4 weeks to measure their individual progress in weight loss.

The following Tables show the nutrient analysis and ingredient content of two dry foods with and without added non-fermentable fiber.

TABLE 6

| | | |
|---|---|---|
| | Canine | Canine |
| | Low CHO Added | Low CHO Added |
| | Non-Fermentable | No Non-fermentable |
| | Fiber; | Fiber; |
| Description | Dry | Dry |

| | | |
|---|---|---|
| Nutrient Analysis | | |
| (100% DM Basis) | | |
| Protein, % | 54.57 | 54.57 |
| Fat, % | 23.37 | 29.91 |
| Total Dietary Fiber, % | 8.81 | 2.76 |
| Fermentable Fiber, % | 0.26 | 0.18 |
| Non-fermentable Fiber, % | 8.55 | 2.58 |
| Ash, % | 4.86 | 4.85 |
| NFE, % Calculated | 12.18 | 9.99 |
| ME, Kcal/kg | 3974 | 4415 |

TABLE 7

| | Canine | Canine |
|---|---|---|
| | Low CHO Added | Low CHO No Added |
| | Non-Fermentable | Non-Fermentable |
| Description | Fiber Dry | Fiber Dry |
| Ingredient | | |
| Corn Gluten Meal, % | 45.80 | 45.60 |
| Animal Fat, % | 15.06 | 21.17 |
| Poultry By-Product Meal, % | 12.80 | 12.89 |
| Soy Isolate, % | 11.79 | 12.11 |
| Cellulose | 6.33 | — |
| Dried Egg Product, % | 2.00 | 2.00 |
| Natural Flavor, % | 3.60 | 3.60 |
| Minerals, % | 1.85 | 1.86 |
| Vitamins, % | 0.77 | 0.77 |
| Total, % | 100.00 | 100.00 |

TABLE 8
EFFECT OF NON-FERMENTABLE FIBER ON WEIGHT LOSS IN OBESE
DOGS FED HIGH PROTEIN, LOW CARBOHYDRATE FOODS

| | | Rate of | Rate of Fat | Rate of |
|---|---|---|---|---|
| | Non-Fermentable | Weight | Tissue | Lean Tissue |
| Formula Description | Dietary Fiber, % | Change, g/d | Change, g/d | Change, g/d |
| Low CHO w/Fiber dry | 8.81 | −42.2 | −34.5 | −7.2 |
| Low CHO w/o Fiber dry | 2.76 | −38.7 | −32.2 | −6.2 |

The food was provided for a span of about 52 to about 112 days.

Results: The weight loss data showed that dogs fed the high protein, low carbohydrate foods had effective weight loss. The rate of weight change and fat tissue change was further increased when fiber was added to the food. Thus, a low carbohydrate food without fiber gave effective weight loss, however, the addition of fiber further increased the rate of weight change and fat change to the benefit of the animal.

1. A food composition for use in a companion animal comprising high protein, high fat, low carbohydrate, and non-fermentable fiber from about 0.75 to about 20 wt %.

2. The composition of claim 1 wherein said companion animal is in need of weight management.

3. The composition of claim 2 wherein said companion animal in need of weight management is overweight.

4. The composition of claim 2 wherein said companion animal in need of weight management is obese.

5. The composition of claim 2 wherein said companion animal in need of weight management is a companion animal with a tendency to gain weight.

6. The composition of claim 2 wherein said companion animal in need of weight management is a companion animal with temporary abnormal carbohydrate metabolism.

7. The composition of claim 2 wherein said companion animal is selected from a dog and a cat.

8. The composition of claim 1 wherein said protein concentration is from about 25 wt % to about 70 wt %.

9. The composition of claim 8 wherein said protein concentration is from about 40 wt % to about 70 wt %.

10. The composition of claim 8 wherein said protein is from about 45 wt % to about 70 wt %.

11. The composition of claim 8 wherein said protein is from about 45 wt % to about 60 wt %.

12. The composition of claim 8 wherein said protein is from about 47 wt % to about 60 wt %.

13. The composition of claim 8 wherein said protein is about 51-53 wt %.

14. The composition of claim 1 wherein said fat concentration is from about 10 wt % to about 70 wt %

15. The composition of claim 14 wherein said fat concentration is from about 20 wt % to about 70 wt %.

16. The composition of claim 14 wherein said fat concentration is from about 20 wt % to about 60 wt %.

17. The composition of claim 14 wherein said fat concentration is about 21 to 23 wt %.

18. The composition of claim 1 wherein said carbohydrate concentration is from about 0 wt % to about 25 wt %

19. The composition of claim 18 wherein said carbohydrate concentration is from about 10 wt % to about 20 wt %.

20. The composition of claim 18 wherein said carbohydrate concentration is from about 12 wt % to about 20 wt %.

21. The composition of claim 18 wherein said carbohydrate concentration is from about 12 wt % to about 15 wt %.

22. The composition of claim 18 wherein said carbohydrate concentration is about 15 to 16wt %.

23. The composition of claim 1 wherein said fiber concentration is from about 0.75 wt % to about 20 wt %

24. The composition of claim 23 wherein said fiber concentration is from about 5 wt % to about 15 wt %.

25. The composition of claim 23 wherein said fiber concentration is from about 7 wt % to about 10 wt %.

26. The composition of claim 23 wherein said fiber concentration is about 8 to 10 wt %.

27. A food composition for use in a companion animal comprising high protein, high fat, low carbohydrate, and non fermentable fiber, wherein said protein concentration is about 51 to 53 wt %, said fat concentration is about 21 to 23 wt %, said carbohydrate concentration is about 15 to 16 wt %, and said fiber concentration is about 8 to 10 wt %.

28. The composition of claim 27 wherein said companion animal is in need of weight management.

29. The composition of claim 28 wherein said companion animal in need of weight management is overweight.

30. The composition of claim 29 wherein said companion animal in need of weight management is obese.

31. The composition of claim 29 wherein said companion animal in need of weight management is a companion animal with a tendency to gain weight.

32. The composition of claim 29 wherein said companion animal in need of weight management is a companion animal with temporary abnormal carbohydrate metabolism.

33. The composition of claim 29 wherein said companion animal is selected from a dog and a cat.

34. A method for managing weight in a companion animal which comprises feeding said companion animal a composition of claim 1.

35. The method of claim 34 wherein said companion animal in need of weight management is overweight.

36. The method of claim 34 wherein said companion animal in need of weight management is obese.

37. The method of claim 34 wherein said companion animal in need of weight management is a companion animal with a tendency to gain weight.

38. The method of claim 34 wherein said companion animal in need of weight management is a companion animal with temporary abnormal carbohydrate metabolism.

39. The method of claim 34 wherein said companion animal is selected from a dog and a cat.

40. A method for managing weight in a companion animal which comprises feeding said companion animal a composition of claim 27.

41. The method of claim 40 wherein said companion animal in need of weight management is overweight.

42. The method of claim 40 wherein said companion animal in need of weight management is obese.

43. The method of claim 40 wherein said companion animal in need of weight management is a companion animal with a tendency to gain weight.

44. The method of claim 40 wherein said companion animal in need of weight management is a companion animal with temporary abnormal carbohydrate metabolism.

45. The method of claim 40 wherein said companion animal is selected from a dog and a cat.
